(19) United States
(12) Patent Application Publication
(10) Pub. No.: US 2021/0350118 A1
(43) Pub. Date: Nov. 11, 2021

(54) System & Method for Body Language Interpretation

(71) Applicant: Arash Golibagh Mahyari, Pensacola, FL (US)

(72) Inventor: Arash Golibagh Mahyari, Pensacola, FL (US)

(21) Appl. No.: 17/308,436

(22) Filed: May 5, 2021

Related U.S. Application Data
(60) Provisional application No. 63/020,753, filed on May 6, 2020.

(51) Int. Cl. G06K 9/00; G10L 17/26; G10L 17/18; G06N 3/04

(52) U.S. Cl. CPC G06K 9/00335; G10L 17/26; G06K 9/00241; G06N 3/0454; G10L 17/18

(57) ABSTRACT

A system and method for reading and interpreting a wide range of nonverbal communicative cues, to include facial expression, pose, gesture, posture, and voice intonation. The output of this system is a scale between zero and one—with the scale indicating the interpretation of the nonverbal communication and accompanying text describing the interpretation. The system determines how a person intends to react and determines whether the person's pronouncements are true or false.

### CROSS-REFERENCES TO RELATED APPLICATIONS

This non-provisional patent application claims priority to Provisional Application No. 63/020,753. The parent application was filed on May 6, 2020. It listed the same inventor.

### STATEMENT REGARDING FEDERALLY SPONSORED RESEARCH OR DEVELOPMENT

Not applicable.

### MICROFICHE APPENDIX

Not Applicable

### BACKGROUND OF THE INVENTION

### 1. Field of the Invention

The present invention pertains to the field of artificial intelligence. More specifically, the invention comprises a system and method for interpreting non-verbal human communication.

### 2. Description of the Related Art

Human beings use two main channels of communication—verbal and nonverbal. Verbal communication includes spoken and written words. Nonverbal communication—sometimes referred to a “body language”—relies on facial expression, voice intonation, physical distance, gesture, posture, body movement, and silence. Studies have shown that most communication between people is non-verbal. Sixty-five percent of interpersonal communication is nonverbal.

Nonverbal communication is often unconscious. The transmitter is not aware of what is being transmitted. It is less rule-bound because people do not receive formal training in the transmission and receipt of nonverbal communication. These facts make nonverbal communication more ambiguous and harder to interpret. The same facts have led to the belief that the proper interpretation of nonverbal communication cannot be automated.

On the other hand, many nonverbal communication signs are universal across different cultures. For instance, pleasant emotions lead to a widened mouth whereas negative emotions lead to constricted facial expressions. Nonverbal communication has been well-studied in psychology, sociology, neuroscience, criminology, anthropology, communication and medicine.

To the best the inventor's knowledge, the inventive system represents the first attempt to automatically interpret body language. Similar works are performed by sign language interpreters. Other similar areas are facial expression and voice intonation recognition. The proposed inventive system preferably includes facial expression and voice intonation. However, they are not used for recognition purposes. Instead, they are used as components of the inventive system to interpret body language and nonverbal communication because nonverbal communication includes facial expression and voice intonation.

### BRIEF SUMMARY OF THE INVENTION

The present inventive system and method reads and interprets a wide range of nonverbal communicative cues, to include facial expression, pose, gesture, posture, and voice intonation. The output of this system is preferably a scale between zero and one —with the scale indicating the interpretation of the nonverbal communication and accompanying text describing the interpretation. The system determines how a person intends to react and determines whether t person's pronouncements are true or false. Because nonverbal communication includes 65% of the information transmitted in interpersonal communication, the inventive system can be used to assess potential criminals, terrorists, and spies. The proposed system allows the automated observation of nonverbal communication cues in order to validate or contradict the verbal communication from the same subject.

### BRIEF DESCRIPTION OF THE SEVERAL VIEWS OF THE DRAWINGS

FIG. 1 is process diagram, showing the operation of the present invention,

FIG. 2 is a block diagram, showing the components of an exemplary computing system configured to carry out the present invention.

FIG. 3 is a block diagram, showing some of the operations carded out by the exemplary computing system.

FIG. 4 is a block diagram, showing some of the operations carried out by the inventive feature extractor.

### REFERENCE NUMERALS IN THE DRAWINGS

10 body language interpretation system
12 subject
14 CCTV
16 camera
18 handheld device
20 device interface
22 computing system
24 display
26 printer
28 cloud server
30 keyboard
32 mouse
34 device interface
36 system memory
38 central processing units
40 graphical processing units
42 video memory
44 system bus
46 output peripheral interface
48 network interface
50 user input interface
52 memory interface
54 memory interface
56 hard disk drive
58 processing system
60 data preprocessing
62 feature extractor
64 fully connected layers
66 pose representation
68 body part identification
70 convolutional and pooling layers
72 convolutional and pooling layers
74 convolutional and pooling layers
76 recurrent neural networks
78 feature vector

### DETAILED DESCRIPTION OF THE INVENTION

An innovative objective of the present invention is to identify all nonverbal cues and interpret them using cameras. This will include facial expression, pose, gesture, and posture. The output of the inventive system is preferably a scale between zero and one, indicating the interpretation of the body language. The types of body language that are preferably recognized by the inventive system include: stress, confidence, disagreement, discomfort, concentration, insecurity, fear, concern, nervousness, and anxiety. These characteristics include two ends of a spectrum. For example, if a person is either extremely comfortable or extremely uncomfortable, this body language is presented with a probability of discomfort. Thus, if the probability is 1, the person is extremely uncomfortable and if it is zero, the person is extremely comfortable.

The significance of the developed system is in deciding how people intend to react and whether their concsious pronouncements (such as verbal statements or written statements) are true or false. Because nonverbal communication includes 65% of the information transmitted in interpersonal communication, the system can be used against criminals, terrorists, and spies to gather all types of information. The proposed system allows the observation of people during their interactions and interviews to validate their responses.

The inventive system consists of several components. The input to the system preferably, comprises static images and videos. Images and videos are obtained from camera live streams and files. The output of the inventive system is a set of scores indicating the level of each interpretation (such as stress, comfort, etc.). The inventive system preferably also outputs text describing the meaning of body language.

The following sections describes some of the components:

1. Input Device: The input will be static images and videos obtained from smartphones, surveillance cameras, camcorders, files, and the like.

2. Computing System: The preferred computing system is a device that processes all images and videos. It consists of several components including: RAM, ROM, HDD, CPUs, GPUs, video memory, user input interface, network interface, and output peripheral interface. These components are connected internally with the system bus. The computing system is connected to a cloud server via the network interface. When the computational power of the computing system is not enough, the computing system sends the data to the cloud server for processing.

3. Processing System: The processing system is deployed on the computing system and is executed by the computing system components, the cloud server, and its peripherals. The processing system includes three main components: These are the Data Preprocessing Component, the Feature Extractor, and the Fully Connected Layers.

The Data Preprocessing Component cleans the input images and videos. Its functions include denoising, adjusting the light, cropping, and separating the human from other objects in the scene.

The Feature Extractor extracts features from the images and videos that make it possible to recognize the body language. To improve the accuracy of the system, the present invention preferably uses several feature extractors. The first feature extractor finds a representation of the human pose. The body pose conveys a lot of information about body language. The pose of a human subject is estimated, and the latent representation of poses will be used to interpret the body language of the subject. The latent representation of the pose is used in the classifier. The second feature extractor identifies body parts (faces, hands, arms, feet, and legs) and passes the images of these regions through several convolutional and pooling layers. This feature extractor identifies facial expression, hand gesture, etc. The third feature extractor gets the whole image or video frame as the input and passes it through several convolutional and pooling layers to extract features. The fourth feature extractor is specific to videos. It passes the frames of the videos through several convolutional and pooling layers, and then pass their outputs through recurrent neural networks to aggregate their features. The output of these four feature extractors are vectors that are stacked together to form a larger vector.

The Fully Connected Layers map all extracted features to the body language. It includes several layers of fully connected neural networks. The input is a vector of features (the larger vector from the feature extractor) and the output is a vector of probabilities. Each entity of the output vector indicates the probability of the associate body language meaning. For example, one entity indicates the probability of the person being stress.

Deep neural networks are used to find the latent representations of hand gestures, arms and legs position, and facial expressions. The latent representations are fed into the classifier for merging with other components.

As for voice intonation, deep neural networks (recurrent and convolutional neural networks) will be used for feature extraction from an individual's speech. The features will be merged with the pose, gesture, and other components for interpreting body language.

A fully connected neural network will be used to merge the latent representations of all components and interpret the body language cues in images, videos, and voice. The output will be a set of values between zero and one indicating the probability of possible interpretations (such as stress, discomfort, disagreement, etc.) and the text describing these interpretations.

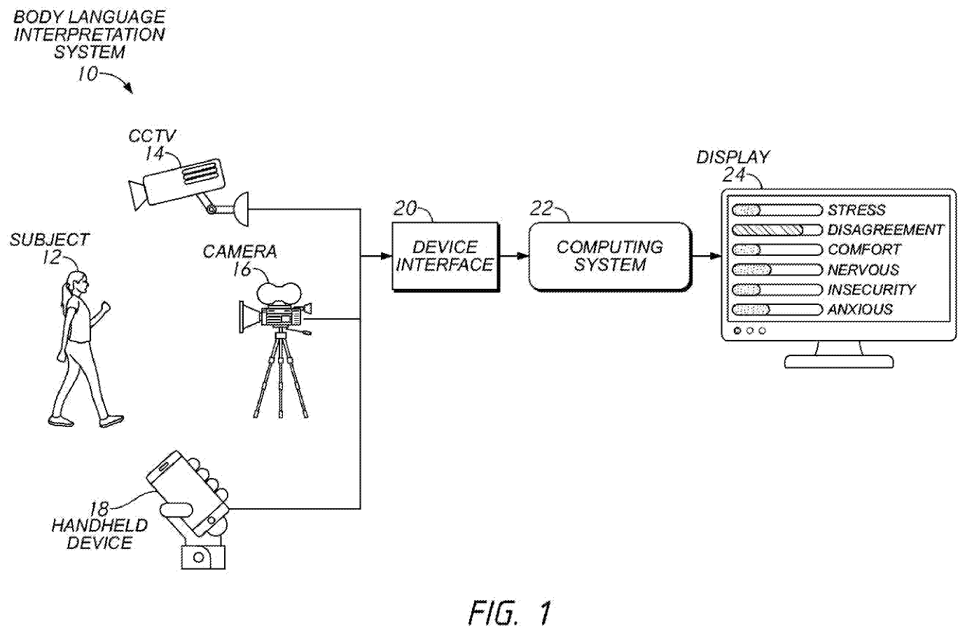

Those skilled in the art will realize that the present invention can be implemented in a wide variety of ways. FIGS. 1-4 represent one preferred embodiment of the invention. This example should not be viewed as limiting.

FIG. 1 depicts the major components of an exemplary body language interpretation system 10. The system is configured to evaluate non-verbal communication from subject 12. Data can be acquired from any suitable device that provides imaging (and preferably audio as well. Exemplary suitable devices include CCTV 14, a video camcorder 16, and a handheld device 18—such as a smartphone including a camera and microphone. All the information from these devices is fed into device interface 20. From the device interface the information is fed into computing system 22. This performs the automated analysis of non-verbal communications and provides the results in display 24.

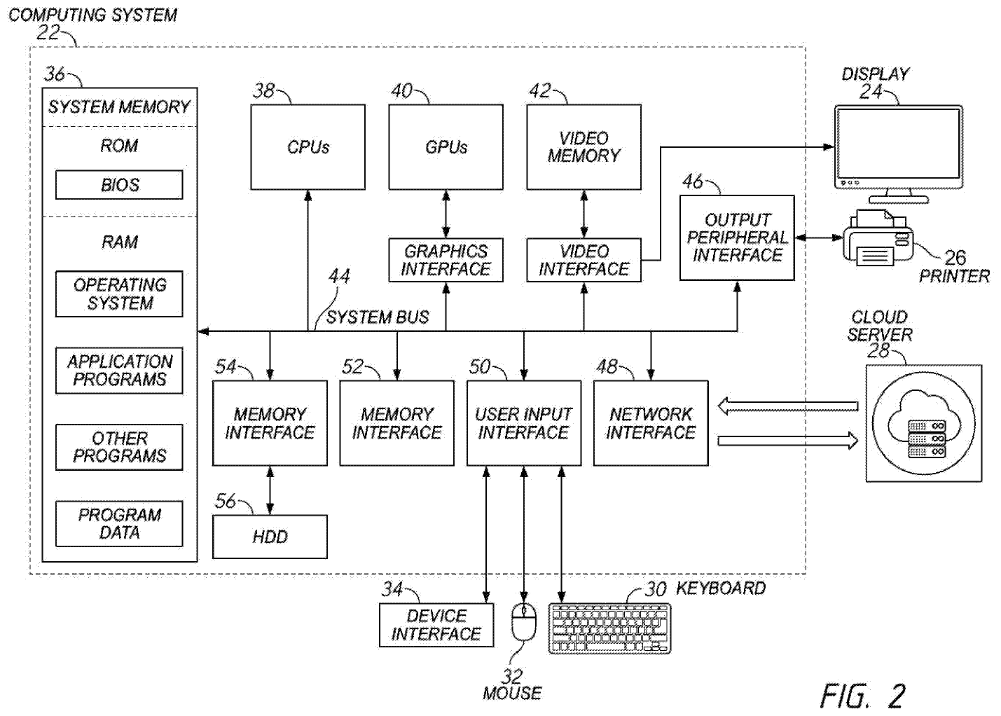

FIG. 2 depicts some internal details of computing system 22. System memory 36 includes BIOS ROM, operating system RAM, application programs RAM, other programs RAM, and program data. RAM. System bus 44 connects the system memory to various other components. One or more CPUs 38 perform the computations. Graphical processing Units 40 drive the graphics display. Video memory 42 interacts with a video interface, and the video interface drives display 24. Output peripheral interface 46 drivers such external devices as printer 26.

Memory interfaces 52, 54 write and read data to storage devices such as hard disk drive 56. User input interface 50 provides access to typical user input devices such as a mouse 32 and keyboard 30. Device interface 34 provides access for other devices.

Network interface 48 provides bidirectional data exchange with cloud server 28. When the local computational power is exceeded the inventive system preferably transfer some of its computational needs to cloud server 28.

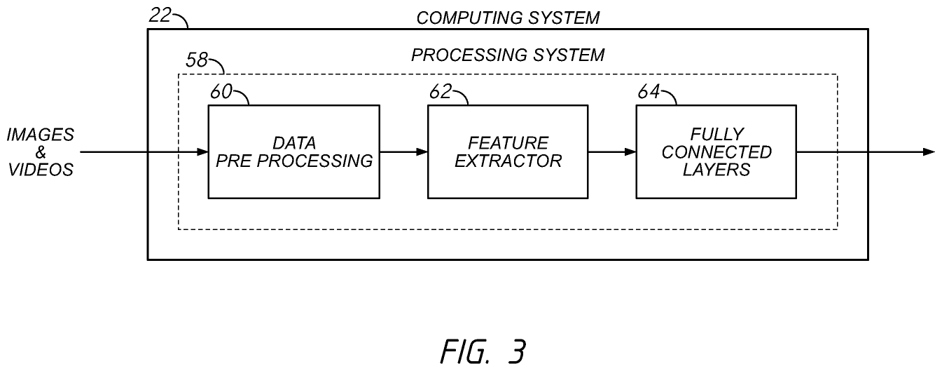

FIG. 3 conceptually shows the three main software operations performed by the inventive computing system 22. The input images and video come into data preprocessing module 60. They next pass to feature extractor 62. Finally, they pass into fully connected layers 64.

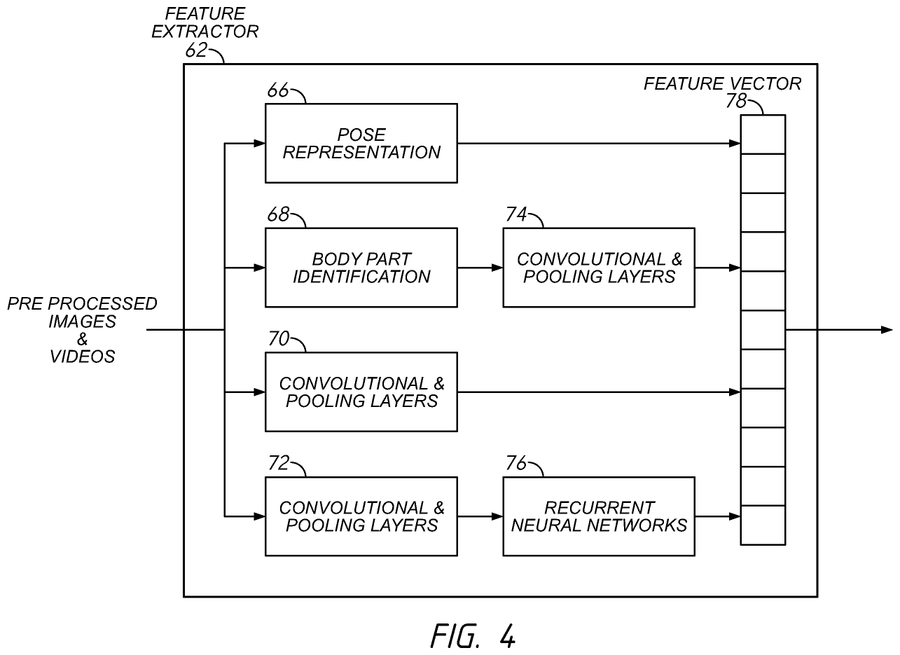

FIG. 4 details the internal operation of a preferred embodiment of feature extractor 62. The preprocessed images and videos come into the Feature Extractor and are processed by pose representation module 66 and body part identification module 68. The pose representation module finds a representation fo the human pose contained in the input data.

The body part identification module identifies body parts (faces, hands, arms, feet, legs, etc.) and passes the image of each specific region through several convolutional and processing layers 74. Additional convolutional and processing layers 70 processes the whole image or video frame and extracts features. The fourth convolutional and processing layer 72 is specific to video. It passes the frames of the videos through several convolutional and pooling layers and passes the outputs through recurrent neural networks 76 to aggregate the features. The outputs of the four extractors 66,68,70,72 are vectors that are stacked together to create feature vector 78.

The inventive system can be applied to many methods. An exemplary method is disclosed in the following scenario. A human subject is interviewed and asked to give verbal or written responses to questions The inventive system is monitoring the human subject during the interviews and used to validate the response the subject has given or call it into doubt. The process can be described as follows:

(1) A human subject is asked to respond to questions;

(2) While the human subject is giving responses, input devices are gathering still images, video images, and/or audio of the human subject;

(3) The data gathered are processed through a computing system in order to provide a set of scores indicating the status of the human subject as to stress, disagreement, comfort nervousness, insecurity, and anxiety; and

(4) Displaying said set of scores to a human system operator.

The preceding description contains significant detail regarding the novel aspects of the present invention. It should not be construed, however, as limiting the scope of the invention but rather as providing illustrations of the preferred embodiments of the invention. Thus, the scope of the invention should be fixed by the claims ultimately drafted, rather than by the examples given.

Having described my invention, I claim:

1. A method for evaluating the veracity of statements made by a human subject, comprising:
(a) obtaining said statements from said human subject;
(b) while said human subject is providing said statements, obtaining digital images of said human subject;
(c) providing said digital images to a computing system;
(d) using said computing system to determine a body pose of said subject from said digital images;
(e) using said computing system to identify images of body parts of said subject;
(f) using said computing system to assign, based on said body pose and said images of said body parts, values for stress, disagreement, comfort, nervousness, insecurity, and anxiety; and
(g) providing said values to a human operator.

2. The method for evaluating the veracity of statements as recited in claim 1, wherein said body parts include a face, hands, arms, feet, and legs.

3. The method for evaluating the veracity of statements as recited in claim 1, wherein said digital images include video images.

4. The method for evaluating the veracity of statements as recited in claim 1, said digital images include still images.

5. A method for evaluating the veracity of statements made by a human subject, comprising:
(a) questioning said human subject in order to obtain said statements from said human subject, said statement including responses to said questions;
(b) while said human subject is providing said statements, obtaining digital images of said human subject;
(c) providing said digital images to a computing system;
(d) using said computing system to determine a body pose of said subject from said digital images;
(e) using said computing system to identify images of body parts of said subject;
(f) using said computing system to assign, based on said body pose and said images of said body parts, values for stress, disagreement, comfort, nervousness, insecurity, and anxiety; and
(g) providing said values to a human operator.

6. The method for evaluating the veracity of statements as recited in claim 5, wherein said body parts include a face, hands, arms, feet, and legs.

7. The method for evaluating the veracity of statements as recited in claim 5, wherein said digital images include video images.

8. The method for evaluating the veracity of statements as recited in claim 5, wherein said digital images include still images.
